(19) United States
(12) Patent Application Publication
(10) Pub. No.: US 2023/0302896 A1
(43) Pub. Date: Sep. 28, 2023

(54) Energy Source Door Assembly

(71) Applicants: Hyundai Motor Company, Seoul (KR); Kia Corporation, Seoul (KR); LS Automotive Technologies Co., Ltd., Anyang-si (KR)

(72) Inventors: Sang Il Kim, Hwaseong-si (KR); Ki Bong Lee, Yongin-si (KR)

(21) Appl. No.: 17/953,833

(22) Filed: Sep. 27, 2022

(30) Foreign Application Priority Data
Mar. 25, 2022 (KR) 10-2022-0037596

(51) Int. Cl. B60K 15/05; H05B 3/34

(52) U.S. Cl. CPC B60K 15/05; H05B 3/34; B60K 2015/0507

(57) ABSTRACT

An embodiment energy source door assembly includes an external cover, a heat cover mounted on the external cover, and a heat film disposed between the external cover and the heat cover, wherein the heat film is configured to generate heat when electric energy is applied thereto. In an embodiment, the energy source door assembly further includes a thermal pad interposed between the heat film and the heat cover.

### CROSS-REFERENCE TO RELATED APPLICATIONS

This application claims the benefit of Korean Patent Application No. 10-2022-0037596, filed on Mar. 25, 2022, which application is hereby incorporated herein by reference.

### TECHNICAL FIELD

The present disclosure relates to an energy source door assembly.

### BACKGROUND

In recent years, as environmental issues have been raised, eco-friendly vehicles have been developed for saving energy and minimizing environmental pollution. In particular, hydrogen fuel cell electric vehicles, bio-diesel vehicles, electric vehicles, and the like are drawing attention as a replacement for existing internal combustion engine vehicles.

An electric vehicle (EV) is configured to have a battery charged with electric energy, and the battery supplies the electric energy to a motor. The electric vehicles (EVs) include battery electric vehicles (BEVs), plug-in hybrid electric vehicles (PHEVs), hybrid electric vehicles (HEVs), and the like. The HEV is configured to combine power of an internal combustion engine and power of an electric motor, and is characterized by higher fuel economy and higher efficiency than an existing internal combustion engine vehicle. The PHEV is designed to charge an HEV battery using an external power supply, and the BEV is only driven using a battery and an electric motor.

All of HEVs, PHEVs, and BEVs may be driven using electric energy. HEVs may be configured to generate electric energy in the vehicle and charge the battery, and PHEVs and BEVs may be configured to receive electric energy from an external power supply and charge the battery. EVs such as PHEVs and BEVs may have a charging port (or charging inlet) for charging the battery, and the charging port may be disposed on an outer panel of a vehicle body adjacent to a wheel of the vehicle. The charging port includes a housing having an opening, a charging receptacle disposed in the housing, and a charging door (or charging cover) opening and closing the opening of the housing. The charging receptacle may be exposed to the outside through the opening of the housing, and a charging connector may be connected to or disconnected from the charging receptacle and be connected to a charging facility, which is an external power supply, through a cable. When the charging connector is connected to the charging receptacle, electric energy may be charged (received) from the charging facility to the battery of the vehicle through the charging receptacle.

In addition, the internal combustion engine vehicle is equipped with a fuel filler apparatus that injects fossil fuel (gasoline, diesel, etc.) into a fuel tank. The fuel filler apparatus includes a fuel filler tube extending from the fuel tank to the panel of the vehicle, a fuel cap detachably joined to an opening of the fuel filler tube, a fuel filler housing provided in the panel of the vehicle to support the fuel filler tube, and a fuel filler door opening and closing the fuel filler housing. As a filler gun is inserted into the fuel filler tube, the fossil fuel may be injected into the fuel tank through the fuel filler tube.

The vehicle includes an energy source receiving apparatus for receiving an energy source such as fossil fuel and hydrogen fuel, and the energy source receiving apparatus includes an energy source door and an energy source door housing mounted in the vehicle body. The energy source door may be mounted to cover or uncover the energy source door housing. The energy source door may be divided into a charging door and a fuel filler door according to types of energy sources, and the energy source door housing may be divided into a charging door housing and a fuel filler door housing.

Meanwhile, in a condition in which an outdoor temperature is extremely low, some components of the vehicle exposed to the outside may be frozen, and the frozen components may not work properly. For example, in extreme cold environmental conditions of North America, Russia, etc., the energy source door such as the charging door of the electric vehicle or the fuel filler door of the internal combustion engine vehicle may be frozen. It may be difficult to open the frozen energy source door. A user may open the frozen energy source door by directly applying heat thereto for a long time using a heater or directly tapping the energy source door, which may cause difficulties or inconveniences in charging or refueling.

The above information described in this background section is provided to assist in understanding the background of the inventive concept, and may include any technical concept which is not considered as the prior art that is already known to those skilled in the art.

### SUMMARY

The present disclosure relates to an energy source door assembly. Particular embodiments relate to an energy source door assembly including a thawing system capable of coping with icing.

Embodiments of the present disclosure can solve problems occurring in the prior art while advantages achieved by the prior art are maintained intact.

An embodiment of the present disclosure provides an energy source door assembly including a thawing system capable of coping with icing caused by cold external conditions.

According to an embodiment of the present disclosure, an energy source door assembly may include an external cover, a heat cover mounted on the external cover, and a heat film disposed between the external cover and the heat cover and generating heat when electric energy is applied thereto.

As the electric energy is applied to the heat film, the heat film may generate heat. The heat may be transferred from the heat film to the external cover and the heat cover, thereby unfreezing the energy source door assembly which has been frozen in cold external conditions.

The energy source door assembly may further include a thermal pad interposed between the heat film and the heat cover.

As the thermal pad is interposed between the heat film and the heat cover, the heat generated from the heat film may be transferred to the outer peripheral edge of the heat cover, and accordingly icing between the energy source door assembly and a vehicle body may be effectively thawed.

The heat film may include a substrate film, a heating element stacked on the substrate film, and an insulation film stacked on the heating element.

The heat film may include a first electrode and a second electrode stacked on the substrate film, and the heating element may be located between the first electrode and the second electrode.

A width of the thermal pad may be greater than a width of the heating element.

Since the width of the thermal pad is greater than the width of the heating element, the heat generated from the heat film may be widely transferred to the outer peripheral edge of the heat cover through the thermal pad.

The heating element may include a first extension portion covering the first electrode and a second extension portion covering the second electrode.

Accordingly, the heat generated from the heating element may be uniformly transferred along a radial direction of the external cover through the first extension portion and the second extension portion.

The heat cover may be made of an aluminum material.

Accordingly, the heat generated from the heat film may be smoothly transferred to the heat cover.

The heat cover may include a sealing member mounted on the outer peripheral edge thereof.

The heat cover and the sealing member may form a unitary one-piece structure through insert molding.

As the heat cover and the sealing member form a unitary one-piece structure through insert molding, heat transfer efficiency between the heat cover and the sealing member may be improved.

The energy source door assembly may cover or uncover an energy source door housing mounted in a vehicle body. The sealing member, the heat cover, and the energy source door housing may define a closed space when the energy source door assembly covers the energy source door housing.

When the heat is transferred from the heat film to the heat cover, the closed space may be heated. As the closed space is heated, the heat may be transferred from the closed space to the icing between the outer peripheral edge of the energy source door assembly and the vehicle body through the sealing lip, and thus the sealing member and the icing may be entirely thawed.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 illustrates a perspective view of an energy source door assembly according to an exemplary embodiment of the present disclosure, which covers an energy source door housing;

FIG. 2 illustrates a perspective view of an energy source door assembly according to an exemplary embodiment of the present disclosure, which uncovers an energy source door housing;

FIG. 3 illustrates an exploded perspective view of an energy source door housing in which an energy source door assembly according to an exemplary embodiment of the present disclosure is mounted;

FIG. 4 illustrates an exploded perspective view of an energy source door assembly according to an exemplary embodiment of the present disclosure;

FIG. 5 illustrates a plan view of an energy source door assembly according to an exemplary embodiment of the present disclosure, which covers an energy source door housing mounted in a vehicle body;

FIG. 6 illustrates a cross-sectional view, taken along line A-A of FIG. 5;

FIG. 7 illustrates an enlarged view of portion B of FIG. 6;

FIG. 8 illustrates an exploded perspective view of a heat cover and a sealing member in an energy source door assembly according to an exemplary embodiment of the present disclosure;

FIG. 9 illustrates a cross-sectional view, taken along line C-C of FIG. 4;

FIG. 10 illustrates the arrangement of a heat film and a thermal pad in an energy source door assembly according to an exemplary embodiment of the present disclosure; and

FIG. 11 illustrates the arrangement of a heat film, a thermal pad, and a heat cover in an energy source door assembly according to an exemplary embodiment of the present disclosure.

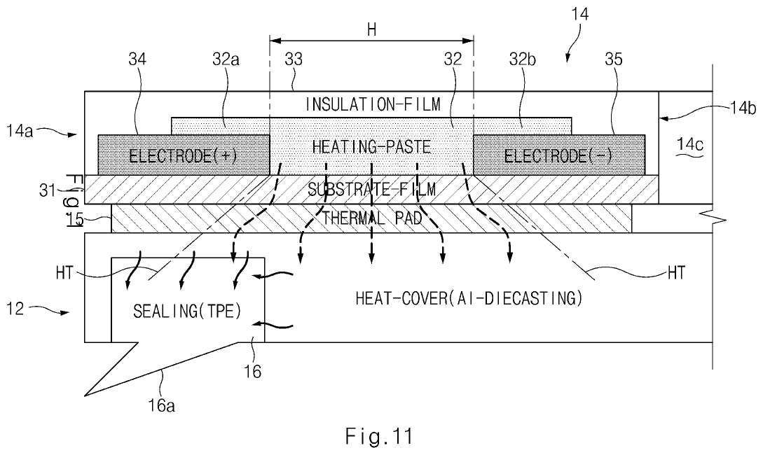

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

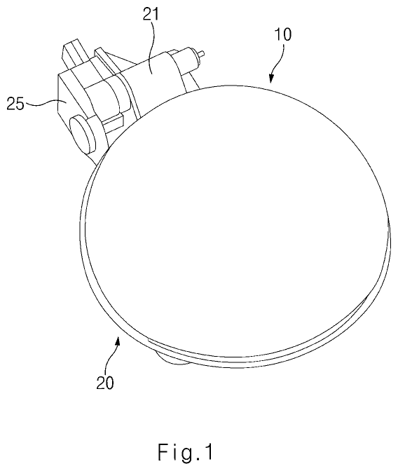

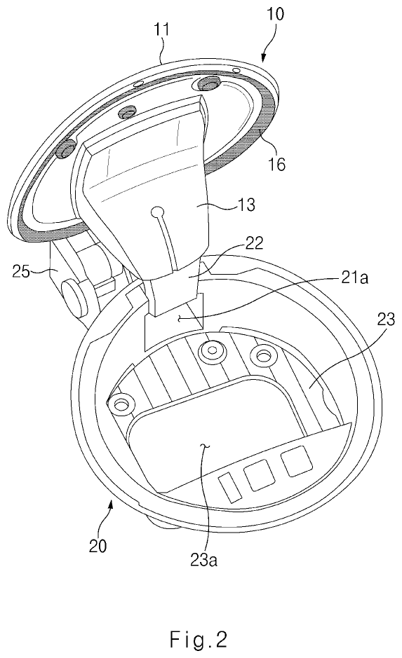

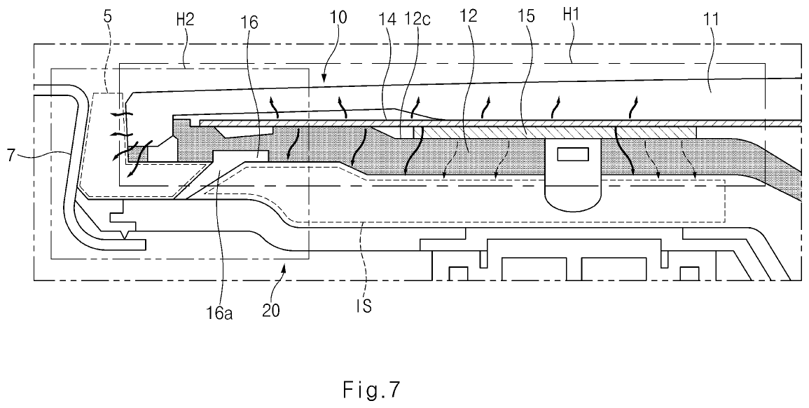

Referring to FIGS. 1 and 2, an energy source door assembly 10 according to an exemplary embodiment of the present disclosure may cover or uncover an energy source door housing 20. The energy source door housing 20 may be mounted in a panel 7 (see FIG. 7) of a vehicle body, and the panel 7 may have a cavity defined therein. The energy source door housing 20 and the energy source door assembly 10 may be received in the cavity of the panel 7.

An end portion of a fuel filler tube or a charging receptacle may be disposed inside the energy source door housing 20. For example, in an electric vehicle, the charging receptacle may be located in the energy source door housing 20 which is a charging door housing of the electric vehicle. In an internal combustion engine vehicle, the end portion of the fuel filler tube or a fuel cap may be located in the energy source door housing 20 which is a fuel filler door housing of the internal combustion engine vehicle. In addition, the energy source door assembly 10 may be a charging door assembly of the electric vehicle to cover or uncover the charging door housing, or may be a fuel filler door assembly of the internal combustion engine vehicle to cover or uncover the fuel filler door housing.

The energy source door assembly 10 may be configured to cover or uncover the energy source door housing 20 so as to receive an energy source such as electric energy, fossil fuel, or hydrogen fuel. That is, the energy source door assembly 10 and the energy source door housing 20 may form an energy source receiving apparatus.

Referring to FIG. 1, as the energy source door assembly 10 is closed, the energy source door housing 20 may be covered so that the receiving of the energy source may be stopped.

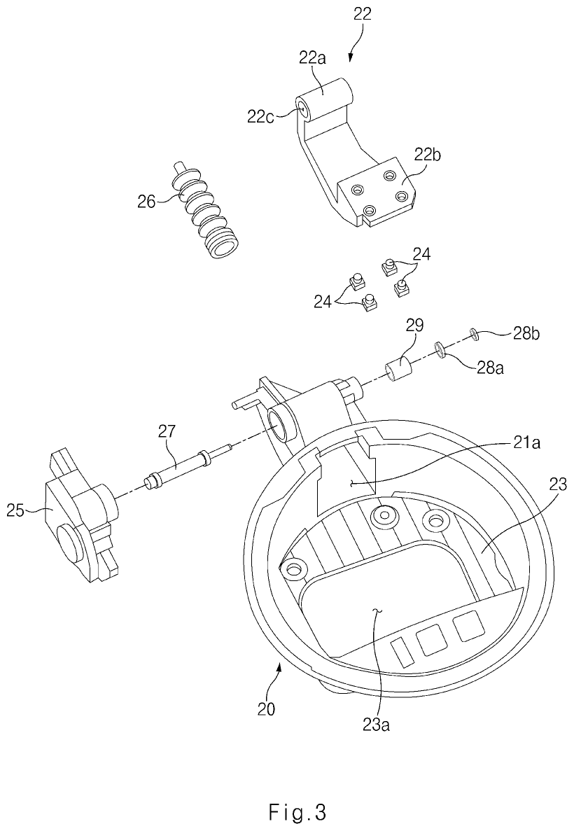

Referring to FIG. 2, as the energy source door assembly 10 is opened, the energy source door housing 20 may be uncovered so that the energy source such as electric energy, fossil fuel, or hydrogen fuel may be received in a battery or a fuel tank of the vehicle through the charging receptacle or the fuel filler tube. Referring to FIG. 3, the energy source door housing 20 may have an internal space defined therein. A bottom plate 23 may be provided on the bottom of the energy source door housing 20, and the bottom plate 23 may have an opening 23a. The end portion of the fuel filler tube of the internal combustion engine vehicle or the charging receptacle of the electric vehicle may be located in the opening 23a of the bottom plate 23 and the internal space of the energy source door housing 20. The energy source door housing 20 may have a hinge lug 21 protruding radially outwardly from the energy source door housing 20, and the hinge lug 21 may have a cavity 21a defined therein. The hinge lug 21 may have a through hole along a central axis thereof, and a shaft 27 may be inserted into the through hole of the hinge lug 21. An actuator 25 may be connected to a first end portion of the shaft 27, and a damper 29 may be connected to a second end portion of the shaft 27. The damper 29 may be mounted on the second end portion of the shaft 27 through a washer 28a and a nut 28b, and the washer 28a and the nut 28b may be made of a synthetic resin material. The actuator 25 may be configured to rotate the shaft 27 around a central axis thereof, and the damper 29 may be configured to dampen the rotational force or rotational speed of the shaft 27.

The energy source door assembly 10 may be pivotally connected to the hinge lug 21 of the energy source door housing 20 through a hinge member 22. The hinge member 22 may have a first end portion 22a inserted into the cavity 21a of the hinge lug 21 and connected to the shaft 27, and a second end portion 22b fixed to the energy source door assembly 10. The first end portion 22a of the hinge member 22 may have a hinge hole 22c Aligned with the Through Hole of the hinge lug 21, and the second end portion 22b of the hinge member 22 may be fixed to a heat cover 12 of the energy source door assembly 10 through a plurality of fasteners 24. The first end portion 22a of the hinge member 22 may be received in the hinge lug 21 through the cavity 21a, and the shaft 27 may be fitted into the hinge hole 22C of the first end portion 22a of the hinge member 22. As the actuator 25 rotates the shaft 27, the first end portion 22a of the hinge member 22 may rotate around the central axis of the shaft 27. Accordingly, the energy source door assembly 10 may be pivotally connected to the energy source door housing 20 by the hinge member 22 and the actuator 25.

The hinge member 22 may have a cavity (not shown) defined between the first end portion 22a and the second end portion 22b, and an electric wire may be received in the cavity (not shown) of the hinge member 22. A plug 26 may be fixed under the hinge lug 21, and the plug 26 may be made of a material such as rubber. The plug 26 may have a hole (not shown) defined therein, and the electric wire may extend through the hole of the plug 26 and be sealed in the plug 26.

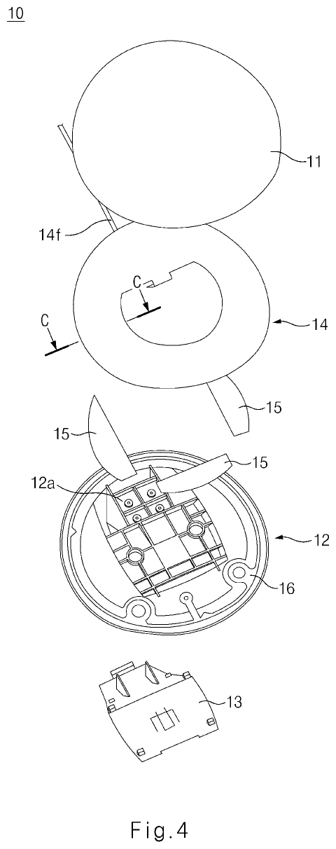

Referring to FIGS. 4, 6, and 7, the energy source door assembly 10 may include an external cover 11 exposed to the outside of the vehicle, the heat cover 12 located below the external cover 11, an internal cover 13 mounted on the heat cover 12, and a heat film 14 interposed between the external cover 11 and the heat cover 12.

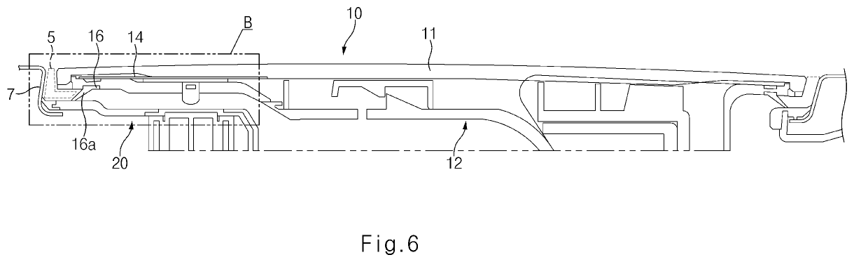

The external cover 11 may be exposed to the outside of the vehicle, and the external cover 11 may be made of a thermally conductive material such as metal. Referring to FIG. 6, an outer peripheral edge of the external cover 11 of the energy source door assembly 10 may be spaced apart from the panel 7 of the vehicle body by a predetermined gap, and icing 5 may be formed in the gap between the energy source door assembly 10 and the panel 7 of the vehicle body.

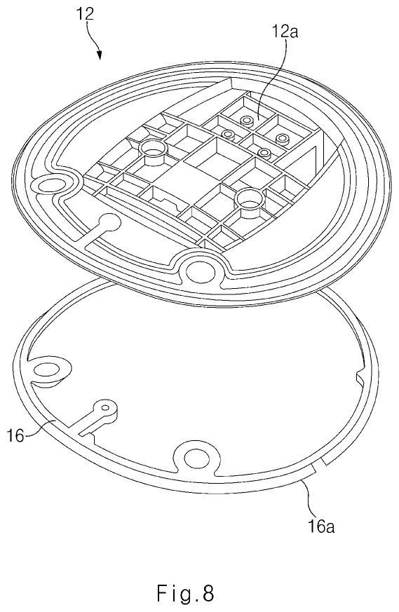

The heat cover 12 may be located under the external cover 11, and the heat cover 12 may be mounted on the external cover 11 using fasteners, welding, and/or the like. The heat cover 12 may be made of a thermally conductive material such as aluminum, and accordingly heat generated from the heat film 14 may be smoothly transferred to the heat cover 12. The heat cover 12 may have a mounting portion 12a provided in the middle thereof, and the second end portion 22b of the hinge member 22 may be fixed to the mounting portion 12a of the heat cover 12 through the fasteners 24. Referring to FIGS. 4 and 8, a sealing member 16 may be mounted on an outer peripheral edge of the heat cover 12. As the energy source door assembly 10 is closed and the energy source door assembly 10 covers the energy source door housing 20, the sealing member 16 may form a seal between the energy source door assembly 10 and the energy source door housing 20. The sealing member 16 may be made of thermoplastic elastomer (TPE). Referring to FIGS. 6 and 7, the sealing member 16 may have a sealing lip 16a protruding toward the energy source door housing 20.

The heat cover 12 may be formed by die-casting an aluminum material, and the heat cover 12 and the sealing member 16 may be integrally joined by insert molding. That is, the sealing member 16 and the heat cover 12 may form a unitary one-piece structure through insert molding.

After the second end portion 22b of the hinge member 22 is fixed to the mounting portion 12a of the heat cover 12, the internal cover 13 may be mounted on the heat cover 12 to cover the second end portion 22b of the hinge member 22. Accordingly, as illustrated in FIG. 2, the second end portion 22b of the hinge member 22 may not be exposed due to the internal cover 13. That is, the internal cover 13 may be exposed to the energy source door housing 20.

The heat film 14 may be interposed between the external cover 11 and the heat cover 12, and the heat film 14 may be electrically connected to a power supply through an electric wire 14f. The heat film 14 may have an opening 14c provided in the center thereof, and the heat film 14 may be prevented from interfering with the mounting portion 12a of the heat cover 12 through the opening 14c. The heat film 14 may have an outer peripheral edge 14a located far from the opening 14c, and an inner peripheral edge 14b facing the opening 14c. The inner peripheral edge 14b may oppose the outer peripheral edge 14a.

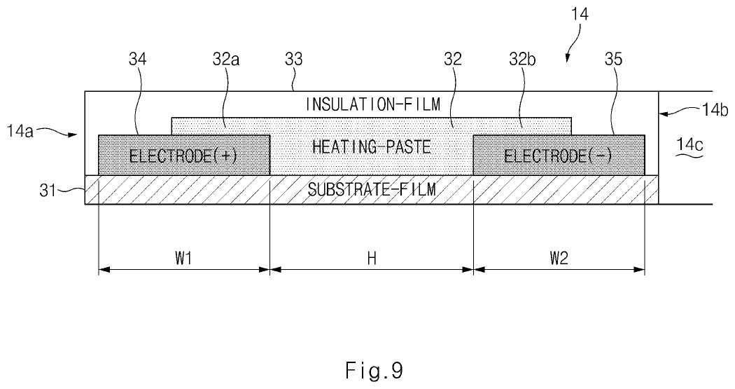

Referring to FIG. 9, the heat film 14 may include a substrate film 31 made of an insulating material, a heating element 32 stacked on the substrate film 31, and an insulation film 33 stacked on the heating element 32. The heating element 32 may be a resistance material made of heating paste such as carbon paste. In particular, the heat film 14 may include a first electrode 34 and a second electrode 35 stacked on the substrate film 31. The first electrode 34 and the second electrode 35 may be arranged on both edge portions of the substrate film 31 and the first electrode 34 and the second electrode 35 may be spaced apart from each other in a width direction of the substrate film 31. The heating element 32 may be located between the first electrode 34 and the second electrode 35. The first electrode 34 and the second electrode 35 may have opposite polarities. For example, the first electrode 34 may be a positive (+) electrode, and the second electrode 35 may be a negative (−) electrode. The first electrode 34 and the second electrode 35 may be electrically connected to the external power supply through the electric wire 14f. The first electrode 34 and the second electrode 35 may be located on both opposing peripheral edges 14a and 14b of the heat film 14, respectively. For example, the first electrode 34 may be located on the outer peripheral edge 14a of the heat film 14, and the second electrode 35 may be located on the inner peripheral edge 14b of the heat film 14.

As the electric energy is applied to the first electrode 34 and the second electrode 35, the heating element 32 may generate heat. Referring to FIG. 9, as the first electrode 34 and the second electrode 35 are located on both edges of the heating element 32, only a portion of the heating element 32 corresponding to a width of the heating element 32 in the entire width of the heat film 14 may be a heating section H, in which heat is generated, and a portion of the heating element 32 corresponding to a width w1 of the first electrode 34 and a portion of the heating element 32 corresponding to a width w2 of the second electrode 35 may be non-heating sections in which heat is not generated. Since heat is not generated in the outer peripheral edge 14a and the inner peripheral edge 14b of the heat film 14 by the first electrode 34 and the second electrode 35, the generation of heat may not be uniform in the entire width of the heat film 14.

The energy source door assembly 10 according to an exemplary embodiment of the present disclosure may further include a thermal pad 15 interposed between the heat film 14 and the heat cover 12. The thermal pad 15 may be made of a thermally conductive material, and thus the thermal pad 15 may uniformly transfer heat from the heat film 14 to the heat cover 12.

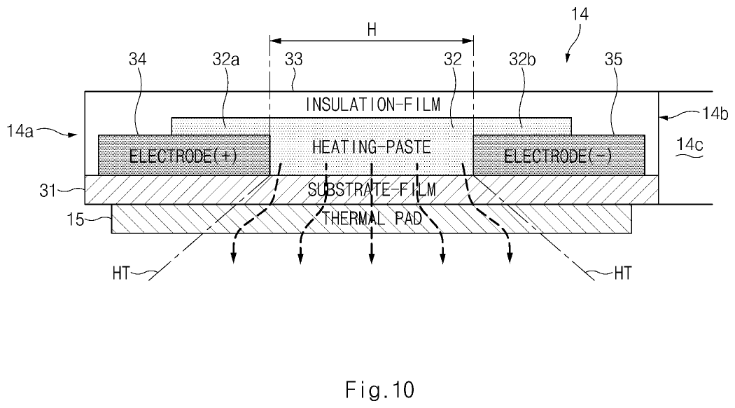

As mentioned above, the heat film 14 may have the non-heating sections including the portion of the heating element 32 corresponding to the width w1 of the first electrode 34 and adjacent to the outer peripheral edge 14a and the portion of the heating element 32 corresponding to the width w2 of the second electrode 35 and adjacent to the inner peripheral edge 14b. Referring to FIG. 10, since the thermal pad 15 directly contacts a bottom surface of the substrate film 31 of the heat film 14, the thermal pad 15 may transfer the heat generated by the heating element 32 of the heat film 14 to the bottom of the heat film 14. In particular, since a width of the thermal pad 15 is greater than the width of the heating element 32 of the heat film 14, the thermal pad 15 may form a heat transfer section HT greater than the heating section H corresponding to the width of the heating element 32. Referring to FIG. 1i, the heat generated from the heating element 32 of the heat film 14 may be transferred to the outer peripheral edge of the heat cover 12 and the sealing member 16 by the thermal pad 15, and thus the heat of the heat film 14 may be uniformly transferred along a radial direction of the heat cover 12.

Referring to FIG. 10, a top surface of the heating element 32 may be located higher than a top surface of the first electrode 34 and a top surface of the second electrode 35. The heating element 32 may include a first extension portion 32a extending from an upper portion of the heating element 32 toward the first electrode 34 and a second extension portion 32b extending from the upper portion of the heating element 32 toward the second electrode 35. The first extension portion 32a may cover at least a portion of the top surface of the first electrode 34, and the second extension portion 32b may cover at least a portion of the top surface of the second electrode 35. Accordingly, the heat generated from the heating element 32 may be uniformly transferred along a radial direction of the external cover 11 through the first extension portion 32a and the second extension portion 32b.

Referring to FIG. 4, the plurality of thermal pads 15 may be at least partially interposed between the heat film 14 and the heat cover 12. The heat film 14 may be a substantially flat thin film, and the heat film 14 may be attached to a bottom surface of the external cover 11 using an adhesive and/or the like. Accordingly, the heat film 14 may be entirely flat under the external cover 11. A top surface of the heat cover 12 facing the heat film 14 may not be entirely flat. Referring to FIG. 7, the heat cover 12 may have a plurality of recessed portions 12c recessed from the top surface thereof to a bottom surface thereof. Accordingly, a gap may be formed between each recessed portion 12C of the heat cover 12 and the heat film 14, and the heat generated by the heat film 14 may not be uniformly transferred to the heat cover 12 due to the gap between the heat cover 12 and the heat film 14. Each thermal pad 15 may be disposed in the recessed portion 12C of the heat cover 12 so that the thermal pad 15 may be inserted into the gap between the heat film 14 and the heat cover 12. Accordingly, the thermal pad 15 may uniformly transfer the heat generated by the heat film 14 along the radial direction of the heat cover 12, and thus the outer peripheral edge of the heat cover 12 and the sealing member 16 may sufficiently receive the heat from the heat film 14.

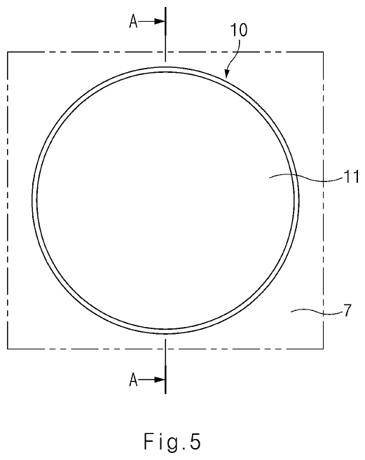

Referring to FIG. 5, when the energy source door assembly 10 is closed and the energy source door assembly 10 covers the energy source door housing 20, a predetermined gap may be formed between the energy source door assembly 10 and the panel 7 of the vehicle body. When the vehicle is exposed to extreme cold conditions, as illustrated in FIGS. 6 and 7, the icing 5 may occur between the outer peripheral edge of the energy source door assembly 10, the panel 7 of the vehicle body, and the outer peripheral edge of the energy source door housing 20. Accordingly, the energy source door assembly 10 may be fixed by the icing 5, which may make the opening of the energy source door assembly 10 difficult. Thus, it may be difficult to receive the energy source such as electric energy and fuel.

Referring to FIG. 7, as the electric energy is applied to the heat film 14, the heat generated by the heat film 14 may be transferred to the external cover 11 located above the heat film 14 and the heat cover 12 located below the heat film 14 (see section H1 in FIG. 7). The heat generated by the heat film 14 may be transferred to the outer peripheral edge of the heat cover 12 and the sealing member 16 by the thermal pad 15 (see section H2 in FIG. 7). As the heat is transferred from the heat film 14 to the outer peripheral edge of the external cover 11, the outer peripheral edge of the heat cover 12, and the sealing member 16, the icing 5 may be thawed.

In addition, as the energy source door assembly 10 is closed and the energy source door assembly 10 covers the energy source door housing 20, the heat cover 12, the sealing lip 16a of the sealing member 16, and the energy source door housing 20 may define a closed space IS. When the heat is transferred from the heat film 14 to the heat cover 12, the closed space IS may be heated. As the closed space IS is heated, the heat may be transferred from the closed space IS to the icing 5 through the sealing lip 16a, and thus the sealing lip 16a of the sealing member 16 and the icing 5 may be entirely thawed.

The main causes of the icing of the energy source door assembly 10 in extreme cold conditions may be the matching of the outer peripheral edge of the external cover 11, the energy source door housing 20, and the sealing member 16, and the gap between the panel 7 of the vehicle body and the energy source door assembly 10. According to an exemplary embodiment of the present disclosure, the heat film 14, the heat cover 12, and/or the thermal pad 15 may form a thawing system in the energy source door assembly 10, and the heat may be uniformly transferred from the heat film 14 to the outer peripheral edge of the external cover 11, the outer peripheral edge of the heat cover 12, and the sealing member 16 so that the icing between the energy source door assembly 10 and the vehicle body may be entirely thawed.

As set forth above, according to exemplary embodiments of the present disclosure, the heat generated by the heat film may be uniformly transferred to the outer peripheral edge of the external cover, the outer peripheral edge of the heat cover, and the sealing member so that the icing between the energy source door assembly and the vehicle body may be entirely thawed.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An energy source door assembly comprising:
an external cover;
a heat cover mounted on the external cover; and
a heat film disposed between the external cover and the heat cover, wherein the heat film is configured to generate heat when electric energy is applied thereto.

2. The energy source door assembly according to claim 1, further comprising a thermal pad interposed between the heat film and the heat cover.

3. The energy source door assembly according to claim 2, wherein the heat film comprises a substrate film, a heating element stacked on the substrate film, and an insulation film stacked on the heating element.

4. The energy source door assembly according to claim 3, wherein the heat film comprises a first electrode and a second electrode stacked on the substrate film, and wherein the heating element is located between the first electrode and the second electrode.

5. The energy source door assembly according to claim 4, wherein a width of the thermal pad is greater than a width of the heating element.

6. The energy source door assembly according to claim 4, wherein the heating element comprises a first extension portion covering the first electrode and a second extension portion covering the second electrode.

7. The energy source door assembly according to claim 1, wherein the heat cover comprises an aluminum material.

8. The energy source door assembly according to claim 1, wherein the heat cover comprises a sealing member mounted on an outer peripheral edge thereof.

9. The energy source door assembly according to claim 8, wherein the heat cover and the sealing member define a unitary one-piece structure through insert molding.

10. The energy source door assembly according to claim 8, wherein:
the energy source door assembly is configured to cover or uncover an energy source door housing mounted in a vehicle body; and
the sealing member, the heat cover, and the energy source door housing define a closed space when the energy source door assembly covers the energy source door housing.

11. A vehicle comprising:
a vehicle body comprising a panel having a cavity defined therein;
an energy source door housing received in the cavity of the panel;
an energy source door assembly received in the cavity of the panel and configured to cover or uncover the energy source door housing, the energy source door assembly comprising:
an external cover;
a heat cover mounted on the external cover; and
a heat film disposed between the external cover and the heat cover, wherein the heat film is configured to generate heat when electric energy is applied thereto.

12. The vehicle according to claim 11, further comprising a thermal pad interposed between the heat film and the heat cover.

13. The vehicle according to claim 12, wherein the heat film comprises a substrate film, a heating element stacked on the substrate film, and an insulation film stacked on the heating element.

14. The vehicle according to claim 13, wherein the heat film comprises a first electrode and a second electrode stacked on the substrate film, and wherein the heating element is located between the first electrode and the second electrode.

15. The vehicle according to claim 14, wherein a width of the thermal pad is greater than a width of the heating element.

16. The vehicle according to claim 14, wherein the heating element comprises a first extension portion covering the first electrode and a second extension portion covering the second electrode.

17. The vehicle according to claim 11, wherein the heat cover comprises an aluminum material.

18. The vehicle according to claim 11, wherein the heat cover comprises a sealing member mounted on an outer peripheral edge thereof.

19. The vehicle according to claim 18, wherein the heat cover and the sealing member define a unitary one-piece structure through insert molding.

20. The vehicle according to claim 18, wherein the sealing member, the heat cover, and the energy source door housing define a closed space when the energy source door assembly covers the energy source door housing.
